(19) United States
(12) Patent Application Publication
(10) Pub. No.: US 2026/0332532 A1
(43) Pub. Date: Oct. 22, 2026

(54) SWITCH POLICIES AND APIS FOR CHANGING STATES IN COMMUNICATION INTERFACE LINKS

(71) Applicant: NVIDIA Corporation, Santa Clara, CA (US)

(72) Inventors: Eric Tyson, Santa Clara, CA (US); Naveen Kumar Narrishetti, Warangal (IN)

(21) Appl. No.: 19/186,391

(22) Filed: Apr. 22, 2025

(51) Int. Cl. H04L 47/25

(52) U.S. Cl. CPC H04L 47/25; G06F 13/4022; G06F 13/4221; G06F 2213/0026

(57) ABSTRACT

A switch connected to multiple devices via multiple respective links initiates a change to a bandwidth of a respective link between the switch and at least one device of the multiple devices. Initiating the change to the bandwidth of the respective link includes sending a bandwidth change request to the at least one device.

### TECHNICAL FIELD

Aspects and embodiments of the present disclosure relate to communication interfaces in computing systems, and in particular to switch policies and APIs for changing states in communication interface links.

### BACKGROUND

A communication interface can enable data transfer between various components in a computing system, such as central processing units (CPUs), graphics processing units (GPUs), data processing units (DPUs), network interface controllers (NICs), data storage devices, etc.

### BRIEF DESCRIPTION OF THE DRAWINGS

Various embodiments in accordance with the present disclosure will be described with reference to the drawings, in which:

FIG. 1A is a block diagram of an example system architecture for a communication system, in accordance with an embodiment;

FIG. 1B is a block diagram of an example system architecture for a communication system, in accordance with an embodiment;

FIG. 1C is a block diagram of an example system architecture for a communication system, in accordance with an embodiment;

FIG. 1D is a block diagram of an example system architecture for a communication system, in accordance with an embodiment;

FIG. 2 is a block diagram of an example switch in a communication system, in accordance with an embodiment;

FIG. 3A is a block diagram of an example communication between two devices via a switch, in accordance with an embodiment;

FIG. 3B is a block diagram of an example communication between a device and a switch, in accordance with an embodiment;

FIG. 3C is a block diagram of an example communication between an application and a switch, in accordance with an embodiment;

FIG. 4A depicts an example link bandwidth policy for a switch, in accordance with an embodiment;

FIG. 4B depicts an example link bandwidth policy for a switch, in accordance with an embodiment;

FIG. 4C depicts an example link bandwidth policy for a switch, in accordance with an embodiment;

FIG. 4D depicts an example link bandwidth policy for a switch, in accordance with an embodiment;

FIG. 5 is a flow diagram of an example method for changing states in communication interface links using switch policies and APIs, in accordance with an embodiment;

FIG. 6 is a flow diagram of an example method for updating link bandwidths in communication interface links, in accordance with an embodiment;

FIG. 7 is a flow diagram of an example method for determining link bandwidth updates in communication interface links, in accordance with an embodiment;

FIG. 8 is a block diagram illustrating an exemplary computer system, in accordance with an embodiment;

FIG. 9 is a block diagram of a computing system having two processing devices coupled to each other and multiple networks, in accordance with an embodiment;

FIG. 10 is a block diagram of a computing system having a CPU and a GPU in a single integrated circuit, in accordance with an embodiment; and

FIG. 11 is a block diagram of a computing system having tensor core GPUs, in accordance with an embodiment.

### DETAILED DESCRIPTION

Aspects of the present disclosure relate to communication interfaces in computing systems, such as multi-lane communication interfaces. A communication interface can enable data transfer between various components in a computing system, such as central processing units (CPUs), graphics processing units (GPUs), data processing units (DPUs), network interface controllers (NICs), data storage devices, etc. A multi-lane communication interface can connect two devices using one or more lanes to form a link, where the lanes in aggregate can achieve higher bandwidth for the link than a single lane. Examples of multi-lane communication interfaces include Peripheral Component Interconnect Express (PCIe), Compute Express Link (CXL), NVLINK, InfiniBand, and Ethernet. Communication interfaces can be used in various applications ranging from data centers (e.g., high-performance computing, artificial intelligence, gaming, etc.) to consumer electronics (e.g., desktops, mobile devices).

Some communication interfaces can support changing link bandwidth to balance factors such as bandwidth needs, power consumption, and similar. For example, some multi-lane communication interfaces can support link width resizing, where the number of lanes used in a link can be dynamically reduced or increased as needed based on the above factors. Bandwidth updates can be achieved via negotiation between the linked devices. However, some communication interfaces may not provide standardized policies or communication methods for bandwidth updates and may instead leave it to devices to determine when to initiate bandwidth updates and whether to accept update requests from linked devices. This can be particularly challenging for switches—specialized devices that connect multiple devices to each other via multiple links. Switches can receive bandwidth update requests from one or more linked devices and should determine whether to accept the update requests and how the update requests should be propagated to other linked devices. However, switches often do not have insight into the data transfer workload of connected devices and can therefore be ineffective in initiating dynamic bandwidth updates with their link partners. Switches can further lack standardized interfaces for receiving and/or initiating bandwidth updates. Furthermore, how switches respond to or initiate bandwidth update requests can depend on associated applications or current modes of operation, and switches are often unaware of these factors.

Aspects of the present disclosure address these and other challenges by providing a communication interface switch that implements multiple policies for updating link bandwidths and that provides an application programming interface (API) for receiving and/or initiating bandwidth update requests with linked devices. Software components such as drivers and applications can select policies and/or set policy configuration parameters that are best suited to the needs of each application and can instruct the switch to apply a given policy as configured. The switch can receive requests from connected devices to update link bandwidths and can determine updated link bandwidths for other connected devices based on a combination of the selected/configured policy, the received requests, and/or the data flow observed by the switch. The switch can communicate with the other connected devices via the API to update the respective link bandwidths. In an embodiment, an API of a switch can conform to an existing protocol of a communication interface, which can enable the switch to determine link bandwidth updates without extensions to the protocol. In an embodiment, an API of a switch can extend a protocol and use new types of messages to communicate additional information not available in the existing protocol.

Various policies can be used by switches in various embodiments. In an upstream passthrough policy, a switch can receive a request to update a bandwidth from a device on a downstream facing port of the switch and provide the same request to a device on an upstream facing port. In a downstream passthrough policy, a switch can receive a request to update a bandwidth from a device on an upstream facing port of the switch and provide the same request to devices on one or more downstream facing ports. In a rollup policy, a switch can provide a request to an upstream facing port based on the combined link bandwidths of one or more downstream facing ports. For example, the switch can request a link bandwidth that is equal to the sum or the maximum of the downstream facing port link bandwidths. Combinations of the above and other policies can be used in various situations.

In an embodiment, a link bandwidth policy can define additional factors to be used by a switch when determining which link bandwidths to request. For example, a switch can determine a link bandwidth to request on an upstream facing port based on the link bandwidths of downstream facing ports as well as the measured bandwidth utilization of the downstream links. In another example, a switch can determine a link bandwidth to request based on the communicated performance requirements of devices on upstream or downstream facing ports (including, e.g., performance requirements accumulated by another upstream/downstream switch). Furthermore, link bandwidth update requests can be prioritized based on, e.g., power or thermal needs. Thus, switches that include the above-described aspects can more effectively propagate and initiate bandwidth updates based on data transfer workloads observed at the switch or communicated to the switch, and switches can further be responsive to characteristic workloads of associated applications or modes of operation.

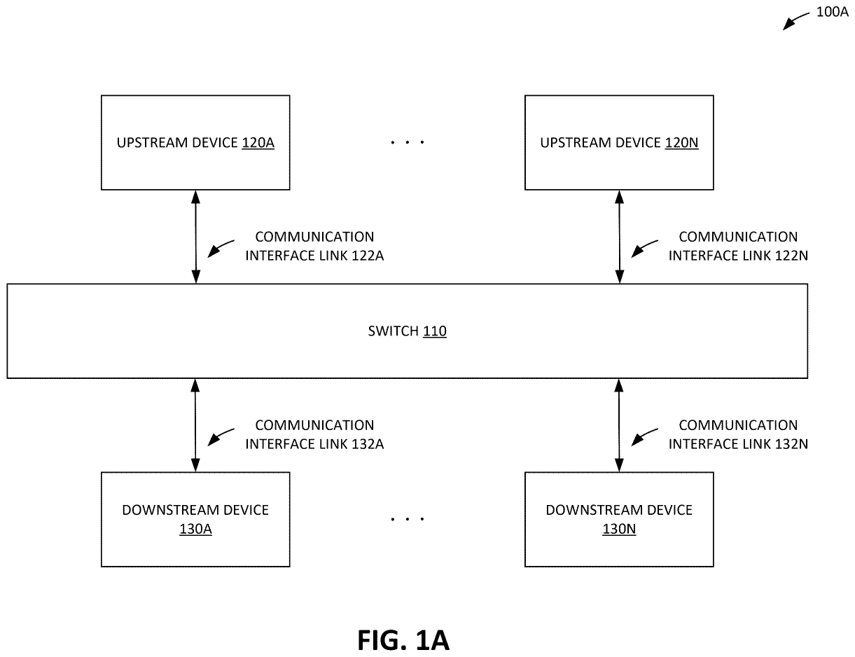

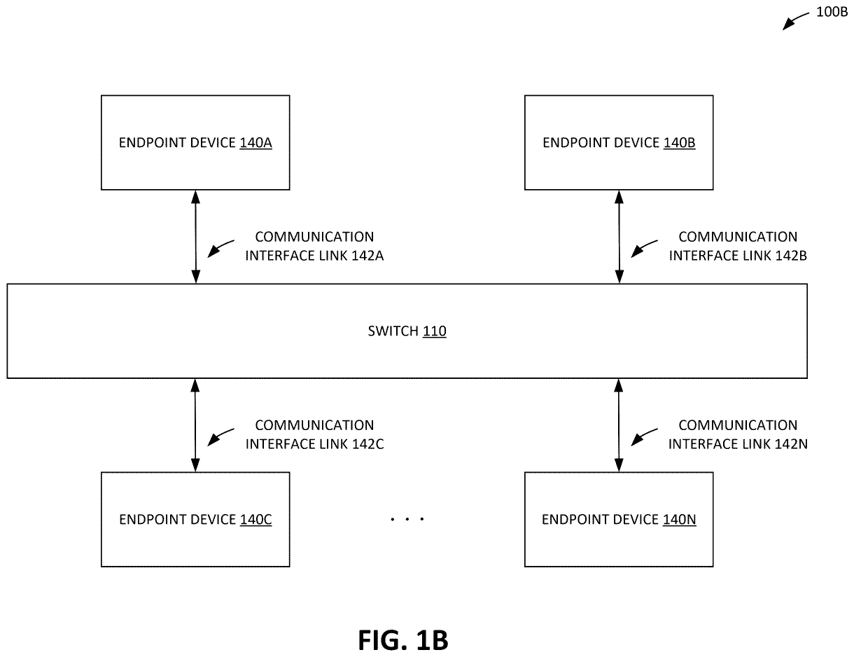

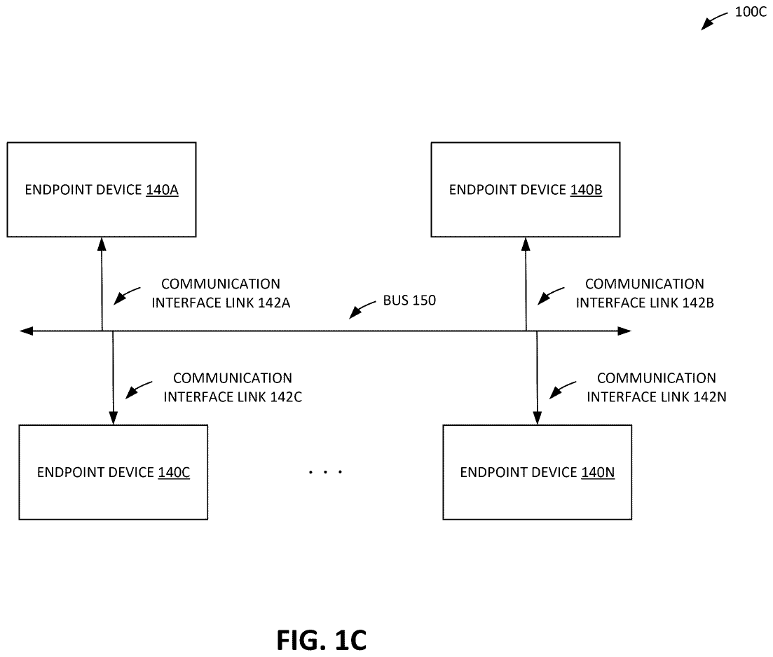

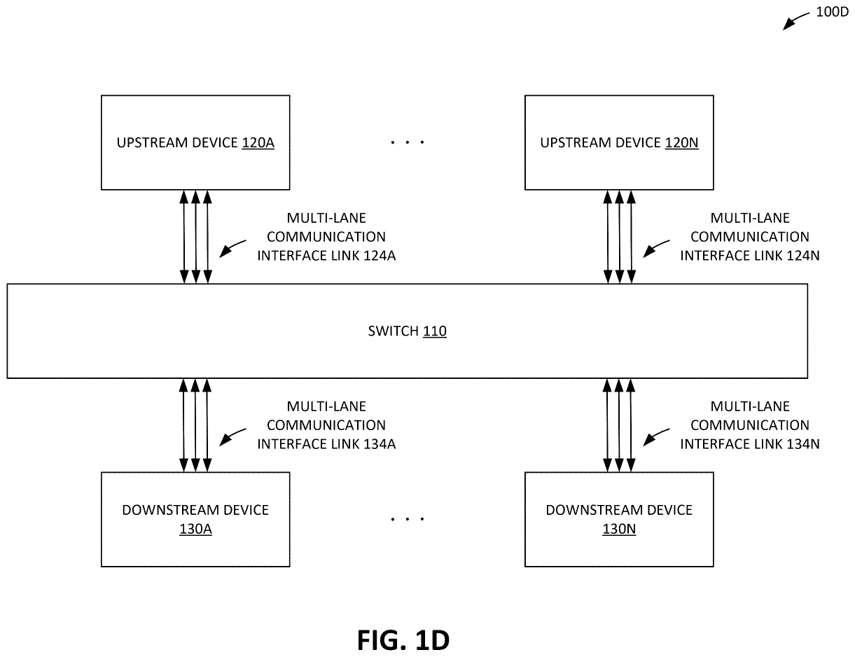

FIG. 1A is a block diagram of an example system architecture 100A for a communication system, in accordance with an embodiment. System architecture 100A (also referred to as “system” herein) includes switch 110, upstream devices 120A-N, and downstream devices 130A-N. System 100A further includes communication interface links 122A-N and 132A-N connecting the above components. In various embodiments, system 100A can include more or fewer components in different configurations than those depicted in FIG. 1A. For example, system 100A can include additional switches operating upstream or downstream from switch 110.

Communication system 100A is associated with a communication interface. The communication interface can define common media and/or protocols that devices and applications running thereon can use to communicate with each other. For example, the communication interface can define one or more layers of the Open Systems Interconnection (OSI) model, such as a physical layer, data link layer, application layer, and so on. Examples of communication interfaces that can be associated with communication system 100A include Peripheral Component Interconnect Express (PCIe), Compute Express Link (CXL), NVLINK, InfiniBand, Ethernet, Universal Serial Bus (USB), Inter-Integrated Circuit (I2C), Serial Peripheral Interface (SPI), and similar.

Devices participating in communication system 100A can be connected together via links compliant with the communication interface. A link can be a unidirectional or bidirectional channel for sending and/or receiving data between two devices and can be associated with underlying physical media and protocols defined by the communication interface. The performance of a link can be characterized in various ways. For example, link bandwidth can refer to how much data can traverse the link in a period of time, and link latency can refer to how much time it takes for data to traverse the link. Link error rate can refer to how often data is lost or corrupted on the link. In various embodiments, some of these performance characteristics can be tunable. For example, a link can be associated with a plurality of bandwidth states that can support more or less bandwidth depending on the needs of the connected devices/applications.

In various embodiments, the communication interface can support different types of devices, such as switches and endpoint devices. Switch 110 can be a device that routes data traffic between two or more devices connected to switch 110. In various embodiments, switch 110 can use look-up tables, addresses embedded in data packets, and/or other techniques to determine which device(s) to route traffic to. In various embodiments, a data packet received at switch 110 can be routable to any of the connected devices or to a subset of connected devices. For example, switch 110 can be a physical device that implements two or more virtual switches, which can each be associated with a respective tree of routable devices connected to switch 110.

Upstream devices 120A-N are endpoint devices that can perform a host or controller role in various embodiments. Upstream devices 120A-N can be connected to one or more downstream devices 130A-N via switch 110. Downstream devices 130A-N can perform a hosted or controlled role in various embodiments. Examples of upstream devices include PCIe root complexes or root ports thereof, and USB host-class devices. Examples of downstream devices include PCIe endpoint devices and USB device-class devices. In an embodiment, a communication system can have a single upstream device and one or more downstream devices.

FIG. 1B is a block diagram of an example system architecture 100B for a communication system, in accordance with an embodiment. System architecture 100B (also referred to as “system” herein) includes switch 110 and endpoint devices 140A-N. System 100B further includes communication interface links 142A-N connecting the above components. In various embodiments, system 100B can include more or fewer components in different configurations than those depicted in FIG. 1B. For example, system 100B can include additional switches operating upstream or downstream from switch 110. System 100B differs from system 100A in that there is no distinction between upstream and downstream devices; all devices can perform host/device, controller/controlled, sender/receiver, or other types of roles. An example communication system that can correspond to system 100B is an Ethernet system. In various embodiments, the device roles of systems 100A-B can be combined with aspects of one or more of systems 100C-D.

FIG. 1C is a block diagram of an example system architecture 100C for a communication system, in accordance with an embodiment. System architecture 100C (also referred to as “system” herein) includes bus 150 and endpoint devices 140A-N. System 100C further includes communication interface links 142A-N connecting the above components. In various embodiments, system 100C can include more or fewer components in different configurations than those depicted in FIG. 1C. For example, system 100C can include additional buses 150. System 100C differs from systems 100A-B in that there is no switch connected multiple devices; rather, all devices share the same physical or virtual media bus 150. An example communication system that can correspond to system 100C is an I2C system. In various embodiments, the bus configuration of system 100C can be combined with aspects of one or more of systems 100A, 100B, or 100D.

FIG. 1D is a block diagram of an example system architecture 100D for a communication system, in accordance with an embodiment. System architecture 100D (also referred to as “system” herein) includes switch 110, upstream devices 120A-N, and downstream devices 130A-N. System 100A further includes multi-lane communication interface links 124A-N and 134A-N connecting the above components. In various embodiments, system 100D can include more or fewer components in different configurations than those depicted in FIG. 1D. For example, system 100D can include additional switches operating upstream or downstream from switch 110. System 100D includes communication interface links can each have two or more lanes. An example communication system that can correspond to system 100D is a PCIe system. In various embodiments, the multi-lane communication interface links of system 100D can be combined with aspects of one or more of systems 100A-C.

Multi-lane communication interface links 124A-N can each have two or more lanes for sending and/or receiving traffic, and the number of active lanes (also referred to as “link width”) can be configurable in various embodiments. For example, multi-lane communication interface link 124A can be configured with one active lane, while multi-lane communication interface link 124B can be configured with four active lanes. In another example, multi-lane communication interface link 124A can transition from one active lane to four active lanes at a point in time. The bandwidth characteristic described above can refer to the overall bandwidth of the link, while a lane bandwidth characteristic can refer to the bandwidth of a single lane. In a multi-lane communication interface link, the link bandwidth can be the sum of the individual lane bandwidths. As described above, some embodiments of communication systems can support tunable link bandwidths, which in systems such as system 100D can include changing the link width (e.g., one to four) or changing the bandwidth of individual lanes (e.g., low bandwidth to high bandwidth).

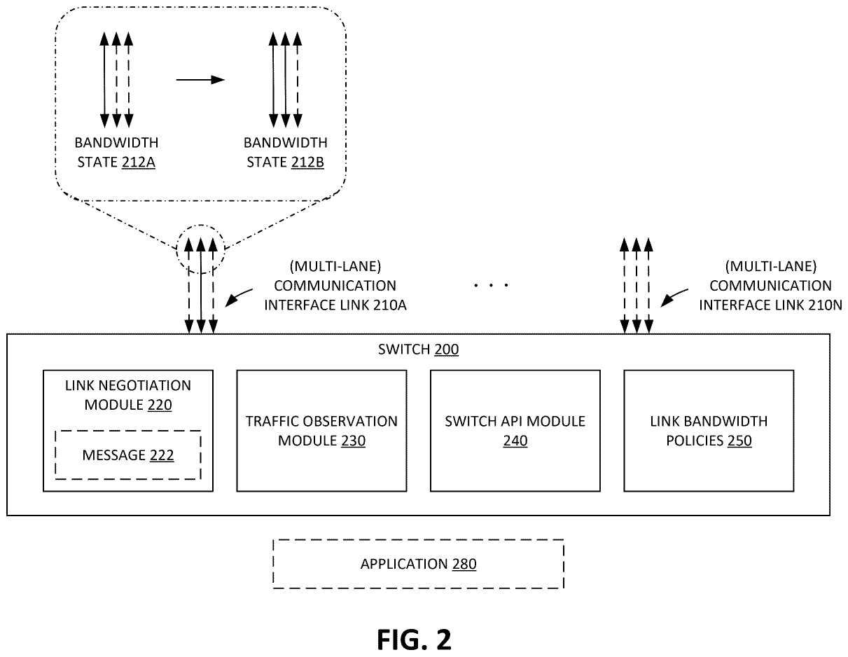

FIG. 2 is a block diagram of an example switch 200 in a communication system, in accordance with an embodiment. In an embodiment, device 200 can be switch 110 of FIGS. 1A-D. Switch 200 is connected to one or more devices via one or more communication interface links 210A-N. Communication interface links 210A-N can be single-lane or multi-lane links in various embodiments. Switch 200 includes link negotiation module 220, traffic observation module 230, switch API module 240, and link bandwidth policies 250. In various embodiments, switch 200 can include more or fewer components than those depicted in FIG. 2. For example, switch 200 can provide more than one type of API. In another example, switch 200 can include routing modules and look-up tables to route messages between attached devices. Switch 200 can be a PCIe device, an Ethernet device, a USB device, or other type of device in various embodiments.

Link negotiation module 220 can communicate with a connected device to configure the connecting link and can implement various protocols to do so. Link negotiation module 220 can be used to initialize a link or update link parameters. For example, link negotiation module 220 can negotiate an updated bandwidth state. In a single-lane or multi-lane communication interface link, an updated bandwidth state can be a transition from a low-bandwidth state to a high-bandwidth state or vice versa. In a multi-lane communication interface link, an updated bandwidth state can be a change in link width, as depicted in bandwidth states 212A-B (a transition from one lane to two lanes). Link negotiation module can send or receive messages (e.g., message 222) to/from connected devices to facilitate link configuration.

Traffic observation module 230 can observe or measure one or more link traffic metrics for one or more of communication interface links 210A-N. Link traffic metrics can include traffic volume, traffic latency, traffic error rates, traffic sources and destinations, or other metrics. Link traffic metrics can be measured for all link traffic or a subset of link traffic, such as traffic destined for a specific device or for switch 200. In an embodiment, traffic observation module 230 can observe contents of link traffic, such as source and destination addresses and/or message payloads. For example, traffic observation module 230 can observe performance-related messages conforming to a protocol of the communication interface and destined for other devices (e.g., L0p messages defined in the PCIe protocol) and identify actual or expected link traffic characteristics from the performance-related messages (e.g., whether a connected device expects to increase traffic sent/received).

Switch API module 240 can provide one or more endpoints for devices and applications (e.g., application 280) to send notifications to switch 200 or request actions or behavior of switch 200 related to link and traffic management. For example, applications can use switch API module 240 to provide link bandwidth policies to switch 200, and devices can use switch API module 240 to request link bandwidth updates or report current or anticipated usage patterns. In an embodiment, endpoints of switch API module 240 can conform to a protocol of a communication interface. In other words, switch 200 can operate upon existing messages specified in a communication protocol without requiring any modifications to the protocol. For example, in a PCIe embodiment, endpoints of switch API module 240 can respond to latency tolerance (LTR) messages of L0p. In an embodiment, endpoints of switch API module 240 can also or alternatively be extensions to a protocol (e.g., vendor-defined extensions) and use new types of messages to communicate with switch 200. Endpoints of switch API module 240 can operate at various layers of the OSI model, such as via data link layer packets or transaction layer packets in a PCIe embodiment.

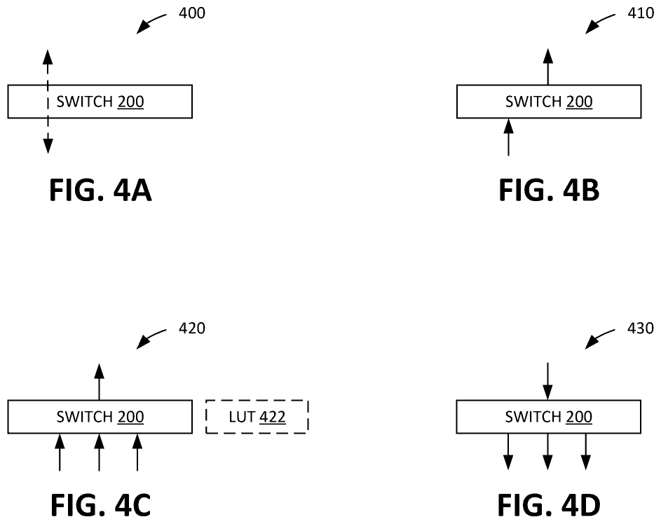

Link bandwidth policies 250 includes one or more policies for initiating link bandwidth updates with attached devices. Link bandwidth policies can be embedded with the switch (e.g., in firmware, which can be unique to a device SKU) and/or can be provided by an external source such as an application, operating system (e.g., via boot settings) or driver (e.g., via switch API module 240). Policies can similarly be selected internally by switch 200 or by an indication from a device or application. Example link bandwidth policies are further described with reference to FIG. 4. Link bandwidth policies can be updated, enabled, or disabled during runtime based on changing applications, user reconfigurations, OS/driver reconfigurations, or similar.

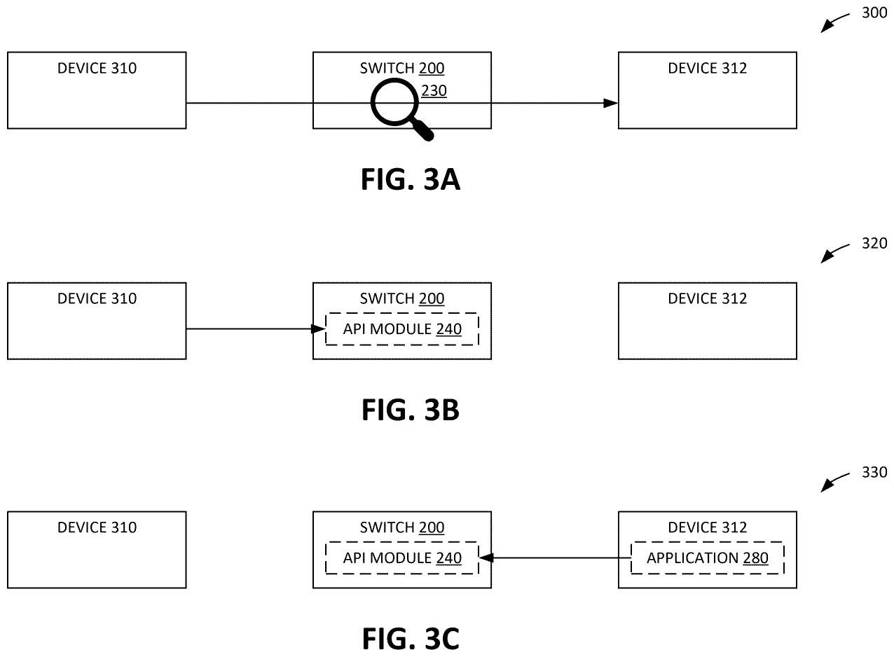

FIG. 3A is a block diagram of an example communication 300 between two devices 310 and 312 via switch 200, in accordance with an embodiment. As depicted, device 310 sends traffic destined for device 312 over a link to switch 200, which forwards the traffic to device 312 over a second link. The traffic can contain data (e.g., related to an application), metadata (e.g., related to the communication itself), instructions, or similar. For example, the traffic can include source and destination addresses and performance-related messages (e.g., reflecting current or anticipated bandwidth, latency, error rates, etc.). While not the intended recipient of the traffic, switch 200 can observe and/or measure the traffic to determine when changes to link state can be useful or necessary. For example, switch 200 can measure current bandwidth and determine if the current bandwidth satisfies one or more threshold values triggering link bandwidth updates. In another example, switch 200 can inspect performance-related messages in the traffic to determine if link bandwidth is to be updated. Performance-related messages can conform to a protocol of the communication interface, and message inspection at switch 200 can be part of the protocol or can be non-protocol activity. An example of a performance-related message that switch 200 can observe in a PCIe embodiment is a latency tolerance (LTR) message.

FIG. 3B is a block diagram of an example communication 320 between device 310 and switch 200, in accordance with an embodiment. As depicted, device 310 sends one or more messages destined for switch 200 via API module 240 of switch 200. The messages can contain link metadata, requests, instructions, or similar. For example, a message can request that a new link bandwidth be negotiated between device 310 and switch 200. The message can conform to a protocol of the communication interface or can be a vendor-specific (e.g., non-protocol) message supported by switch 200.

FIG. 3C is a block diagram of an example communication 330 between application 280 and switch 200, in accordance with an embodiment. As depicted, application 280 is associated with device 312 and sends one or more messages via device 312 to switch 200 via API module 240. The messages can contain link metadata, requests, instructions, or similar. For example, a message can provide or indicate one or more link bandwidth policies to be implemented by switch 200. In another example, a message can indicate a current or anticipated traffic pattern for a link between device 312 and switch 200 (and potentially other devices involved in the application), such as current/anticipated bandwidth, data/usage type, allowable latency, etc. The message can conform to a protocol of the communication interface or can be a vendor-specific message supported by switch 200. The message can originate directly from application 280, from a related driver (e.g., a driver for device 312 or switch 200), or other software endpoint.

FIGS. 4A-D depict example link bandwidth policies 400-430 for switch 200, in accordance with an embodiment. Referring to FIG. 4A, policy 400 is a follow-only policy, where switch 200 supports passthrough of existing protocols (e.g., L0p) but does not initiate any link bandwidth updates. Referring to FIG. 4B, policy 410 is a downstream-facing port passthrough policy, where switch 200 initiates a matching link bandwidth update on an upstream-facing port when a downstream-facing port sends a request. Referring to FIG. 4C, policy 420 is a downstream-facing port rollup policy, where switch 200 initiates a link bandwidth update on an upstream-facing port based on the combined states of one or more downstream-facing ports. For example, switch 200 can initiate a link bandwidth update that corresponds to a sum of the link bandwidths of the downstream-facing ports, or that corresponds to a maximum of the link bandwidths of the downstream-facing ports. In another example, switch 200 can use look-up table 422 to select a link bandwidth update for the upstream-facing port based on the states of the downstream-facing ports. Referring to FIG. 4D, policy 430 is an upstream-facing port passthrough policy, where switch 200 initiates matching link bandwidth updates on one or more downstream-facing ports when an upstream-facing port sends a request.

Other policies not depicted in FIGS. 4A-D can be used with switch 200 as well. For example, a policy based on hardware bandwidth monitoring (e.g., as performed by traffic observation module 230) can use one or more threshold values to trigger link bandwidth updates. Other policies can rely on triggers from software endpoints, such as software requests for updated link bandwidths.

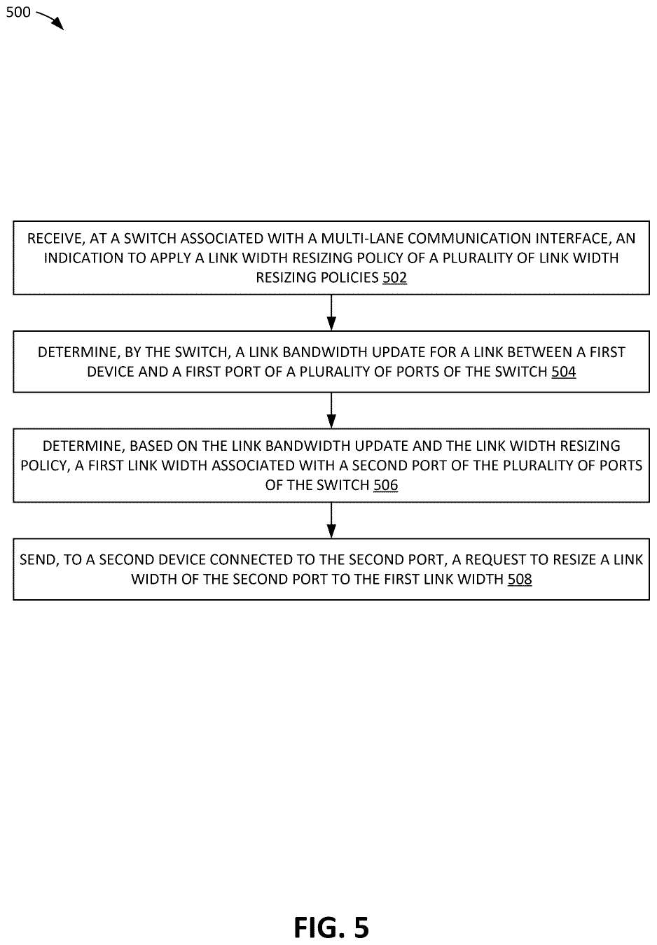

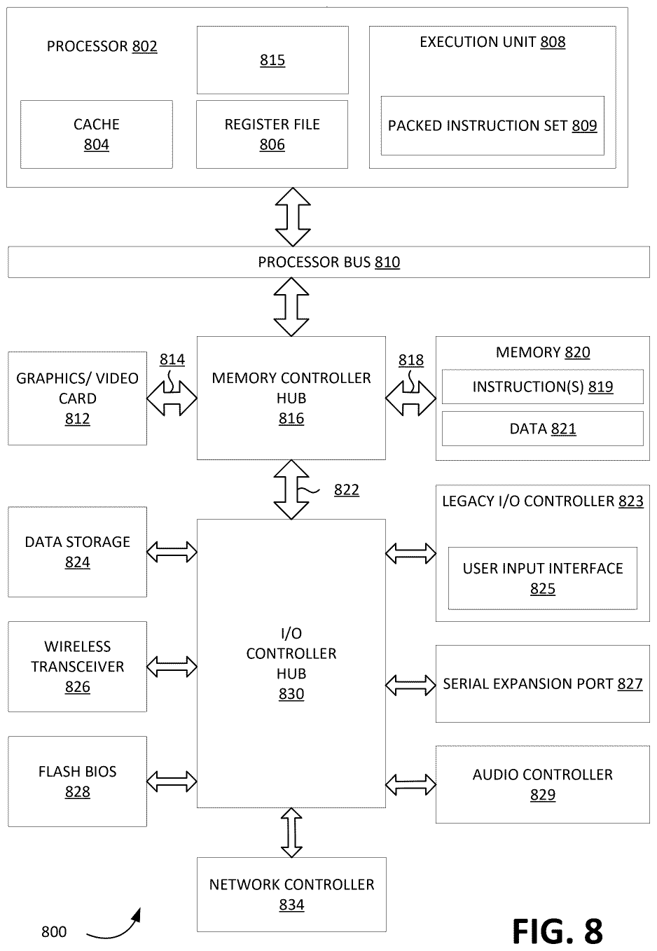

FIG. 5 is a flow diagram of an example method 500 for changing states in communication interface links using switch policies and APIs, in accordance with at least one embodiment. Method 500 can be performed by processing logic that can comprise hardware (e.g., circuitry, dedicated logic, etc.), computer-readable instructions such as software or firmware (e.g., run on a general-purpose computing system or a dedicated machine), or a combination thereof. For instance, an example system can include a memory and a processing device coupled to the memory device to perform operations comprising the blocks of method 500. Method 500 can also be associated with a set of instructions stored on a non-transitory computer-readable medium (e.g., magnetic or optical disk, etc.). The instructions, when executed by a processing device, can cause the processing device to perform operations comprising the blocks of method 500. In at least one embodiment, method 500 is performed by switch 110 of FIGS. 1A-D, switch 200 of FIG. 2, or components thereof. In at least one embodiment, method 500 is performed by computing system 800 of FIG. 8. In some embodiments, blocks depicted in FIG. 5 could be performed simultaneously or in a different order than depicted. Various embodiments can include additional blocks not depicted in FIG. 5 or a subset of blocks depicted in FIG. 5.

At block 502, processing logic of a switch associated with a multi-lane communication interface receives an indication to apply a link width resizing policy of a plurality of link width resizing policies. The indication can be a policy itself or a reference to a policy stored (or otherwise available) at the switch (e.g., link bandwidth policies 250). In an embodiment, the indication to apply the link width resizing policy is associated with an application (e.g., application 280), which can be a high-performance computing (HPC) application, an artificial intelligence (AI) application, a gaming application, or other type of application. For example, a system (e.g., a driver) can identify or infer (e.g., based on work/data submitted) a type of application in use and provide an appropriate policy indication to the switch. In another example, a system can identify a specific application (e.g., specific game, specific HPC application, etc.) and provide an appropriate policy indication to the switch. In an embodiment, the indication can be a runtime update based on changing workload or user reconfiguration.

At block 504, the processing logic determines a link bandwidth update for a link between a first device and a first port of a plurality of ports of the switch. The link can be one of communication interface links 210A-N, and the plurality of ports can each be associated with a respective link of communication interface links 210A-N. The link bandwidth update can be determined by the switch in various ways, such as by monitoring link traffic and/or receiving messages at an API of the switch. In one example, the switch can receive, from the first device, a request to resize a link width of the first port to a second link width. This request can be directed to the switch itself, e.g., via an API of the switch (e.g., a vendor-specific protocol). In a second example, the switch can receive, from the first device, a performance-related message, which can conform to a protocol of the communication interface (e.g., the PCIe protocol), and which can be destined for another device connected to the switch. Performance-related messages can provide performance data (e.g., bandwidth, latency, error rate) or can be performance requests (e.g., changing a link bandwidth or latency). L0p latency tolerance (LTR) messages are examples of such performance-related messages. In a third example, the switch can determine a bandwidth utilization metric based on data flow observed at the first port. Data flow observed at the first port can include traffic volume, message error rates, latency, or similar metrics. These metrics can be used individually or combined to derive the bandwidth utilization metric.

At block 506, the processing logic determines, based on the link bandwidth update and the link width resizing policy, a first link width associated with a second port of the plurality of ports of the switch. Various link width resizing policies are described with reference to FIG. 4. For example, the first port can be a downstream-facing port, the second port can be an upstream-facing port, the link width resizing policy can be a passthrough policy (e.g., policy 410), and the first link width can be equal to the second link width. In another example, the first port can be a downstream-facing port, the second port can be an upstream-facing port, one or more downstream-facing third ports can be associated with one or more respective third link widths, and the first link width can be equal to a sum or a maximum of the second link width and the one or more respective third link widths (e.g., policy 420). In another example, the first port can be an upstream-facing port, the second port can be a downstream-facing port, the link width resizing policy can be a passthrough policy (e.g., policy 430), the first link width can be equal to the second link width, and the processing logic can further send, to a third device connected to a downstream-facing third port of the plurality of ports of the switch, a request to resize a link width of the third port to the first link width.

At block 508, the processing logic sends, to a second device connected to the second port, a request to resize a link width of the second port to the first link width. The request can conform to a protocol of the communication interface or can be a vendor-specific protocol. In an embodiment, the first port and the second port are the same port, and the first device and the second device are the same device. For example, the switch can observe traffic patterns originating from the first device and then send a request to resize the link with the first device based on the observed traffic patterns and one or more policies.

In an embodiment, the switch is a logical switch of a plurality of logical switches hosted by a physical switch. The links and ports described above can belong to one of the plurality of logical switches, and the link width resizing policy can be applied to one or more of the plurality of logical switches. For example, an embodiment of a physical PCIe switch can be partitioned such that a first subset of lanes of the physical switch are associated with a first logical switch, and a second subset of lanes of the physical switch are associated with a second logical switch. In another example, a physical Ethernet switch can operate as one or more logical switches for VLAN-tagged Ethernet frames.

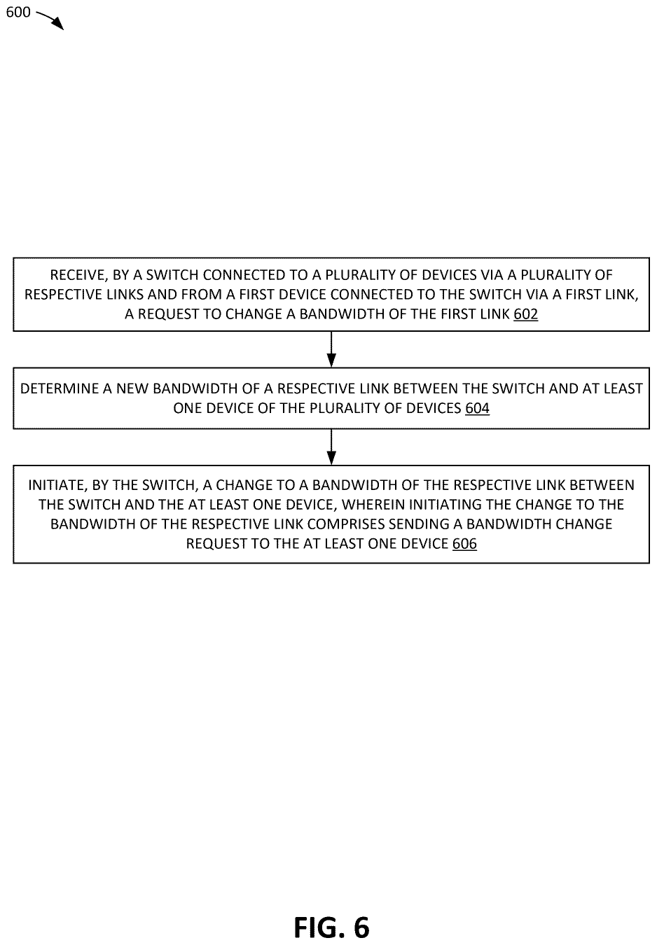

FIG. 6 is a flow diagram of an example method 600 for updating link bandwidths in communication interface links, in accordance with at least one embodiment. Method 600 can be performed by processing logic that can comprise hardware (e.g., circuitry, dedicated logic, etc.), computer-readable instructions such as software or firmware (e.g., run on a general-purpose computing system or a dedicated machine), or a combination thereof. For instance, an example system can include a memory and a processing device coupled to the memory device to perform operations comprising the blocks of method 600. Method 600 can also be associated with a set of instructions stored on a non-transitory computer-readable medium (e.g., magnetic or optical disk, etc.). The instructions, when executed by a processing device, can cause the processing device to perform operations comprising the blocks of method 600. In at least one embodiment, method 600 is performed by switch 110 of FIGS. 1A-D, switch 200 of FIG. 2, or components thereof. In at least one embodiment, method 600 is performed by computing system 800 of FIG. 8. In some embodiments, blocks depicted in FIG. 6 could be performed simultaneously or in a different order than depicted. Various embodiments can include additional blocks not depicted in FIG. 6 or a subset of blocks depicted in FIG. 6.

At block 602, processing logic of a switch connected to a plurality of devices via a plurality of respective links receives, from a first device connected to the switch via a first link, a request to change a bandwidth of the first link. In an embodiment, the request is received via in API of the switch (e.g., a vendor-specific message).

At block 604, the processing logic determines a new bandwidth of a respective link between the switch and at least one device of the plurality of devices. In an embodiment, the new bandwidth of the respective link is determined based on a performance request or other performance-related message received at the switch via an API (e.g., at switch API module 240). In an embodiment, the determining is based on traffic flow measured at the switch (e.g., by traffic observation module 230). In an embodiment, the determining is based on a link bandwidth policy of the switch (e.g., one of link bandwidth policies 250). In an embodiment, the link bandwidth policy is associated with a type of application or a specific application, such as HPC applications, AI applications, gaming applications, etc. as described above. In an embodiment, the first device of block 602 is different from the at least one device of block 604. In an embodiment, the first device is included in the at least one device.

At block 606, the processing logic initiates a change to a bandwidth of the respective link between the switch and the at least one device, wherein initiating the change to the bandwidth of the respective link comprises sending a bandwidth change request to the at least one device. The bandwidth change request can conform to a protocol of a communication interface or can be a vendor-specific message. In an embodiment, the switch is associated with a multi-lane communication interface, and the request to change the bandwidth of the respective link is a request to resize a link width of the respective link.

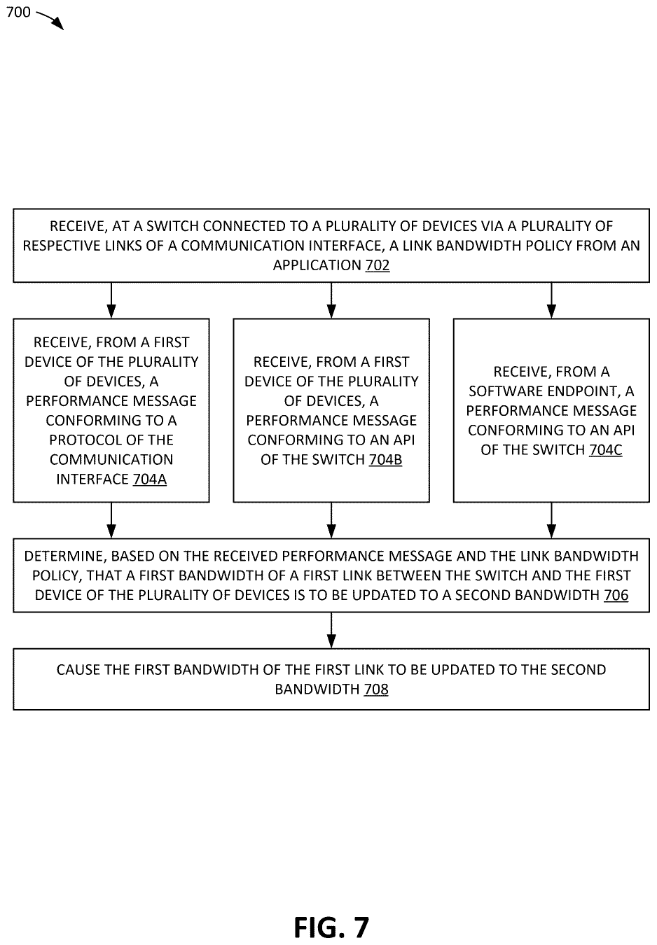

FIG. 7 is a flow diagram of an example method 700 for determining link bandwidth updates in communication interface links, in accordance with at least one embodiment. Method 700 can be performed by processing logic that can comprise hardware (e.g., circuitry, dedicated logic, etc.), computer-readable instructions such as software or firmware (e.g., run on a general-purpose computing system or a dedicated machine), or a combination thereof. For instance, an example system can include a memory and a processing device coupled to the memory device to perform operations comprising the blocks of method 700. Method 700 can also be associated with a set of instructions stored on a non-transitory computer-readable medium (e.g., magnetic or optical disk, etc.). The instructions, when executed by a processing device, can cause the processing device to perform operations comprising the blocks of method 700. In at least one embodiment, method 700 is performed by switch 110 of FIGS. 1A-D, switch 200 of FIG. 2, or components thereof. In at least one embodiment, method 700 is performed by computing system 800 of FIG. 8. In some embodiments, blocks depicted in FIG. 7 could be performed simultaneously or in a different order than depicted. Various embodiments can include additional blocks not depicted in FIG. 7 or a subset of blocks depicted in FIG. 7.

At block 702, processing logic of a switch connected to a plurality of devices via a plurality of respective links of a communication interface receives a link bandwidth policy from an application. The application can be a specific application or type of application such as HPC applications, AI applications, gaming applications, etc., as previously described.

At block 704A, the processing logic receives, from a first device of the plurality of devices, a performance message conforming to a protocol of the communication interface. In am embodiment, the performance message is associated with a bandwidth or latency of the first link. In an embodiment, the received performance message is to be forwarded to a second device of the plurality of devices. For example, the performance message can be a latency tolerance (LTR) message addressed to the second device.

Alternatively, at block 704B, the processing logic receives, from a first device of the plurality of devices, a performance message conforming to an API of the switch, such as a vendor-specified protocol. In an embodiment, the received performance message is a request to update the first bandwidth of the first link.

Alternatively, at block 704C, the processing logic receives, from a software endpoint, a performance message conforming to an API of the switch. For example, a driver or application can communicate a current or anticipated traffic pattern to the switch via the API.

At block 706, the processing logic determines, based on the received performance message and the link bandwidth policy, that a first bandwidth of a first link between the switch and the first device of the plurality of devices is to be updated to a second bandwidth.

At block 708, the processing logic causes the first bandwidth of the first link to be updated to the second bandwidth. For example, the processing logic can send a message or otherwise negotiate a bandwidth update with the linked device. In an embodiment, the switch is associated with a multi-lane communication interface, and causing the first bandwidth of the first link to be updated to the second bandwidth comprises causing a first link width associated with the first bandwidth to be resized to a second link width associated with the second bandwidth.

FIG. 8 is a block diagram illustrating an exemplary computer system, which may be a system with interconnected devices and components, a system-on-a-chip (SOC) or some combination thereof 800 formed with a processor that may include execution units to execute an instruction, according to at least one embodiment. In at least one embodiment, computer system 800 may include, without limitation, a component, such as a processor 802 to employ execution units including logic to perform algorithms for process data, in accordance with present disclosure, such as in embodiment described herein. In at least one embodiment, computer system 800 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 800 may execute a version of WINDOWS′ operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, edge devices, Internet-of-Things (“IoT”) devices, or any other system that may perform one or more instructions in accordance with at least one embodiment.

In at least one embodiment, computer system 800 may include, without limitation, processor 802 that may include, without limitation, one or more execution units 808 to perform machine learning model training and/or inferencing according to techniques described herein. In at least one embodiment, computer system 800 is a single processor desktop or server system, but in another embodiment computer system 800 may be a multiprocessor system. In at least one embodiment, processor 802 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 802 may be coupled to a processor bus 810 that may transmit data signals between processor 802 and other components in computer system 800.

In at least one embodiment, processor 802 may include, without limitation, a Level 1 (“L1”) internal cache memory (“cache”) 804. In at least one embodiment, processor 802 may have a single internal cache or multiple levels of internal cache. In at least one embodiment, cache memory may reside external to processor 802. Other embodiments may also include a combination of both internal and external caches depending on particular implementation and needs. In at least one embodiment, register file 806 may store different types of data in various registers including, without limitation, integer registers, floating point registers, status registers, and instruction pointer register.

In at least one embodiment, execution unit 808, including, without limitation, logic to perform integer and floating-point operations, also resides in processor 802. In at least one embodiment, processor 802 may also include a microcode (“ucode”) read-only memory (“ROM”) that stores microcode for certain macro instructions. In at least one embodiment, execution unit 808 may include logic to handle a packed instruction set 809. In at least one embodiment, by including packed instruction set 809 in an instruction set of a general-purpose processor 802, along with associated circuitry to execute instructions, operations used by many multimedia applications may be performed using packed data in a general-purpose processor 802. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 808 may also be used in microcontrollers, embedded processors, graphics devices, DSPs, and other types of logic circuits. In at least one embodiment, computer system 800 may include, without limitation, a memory 820. In at least one embodiment, memory 820 may be implemented as a Dynamic Random Access Memory (“DRAM”) device, a Static Random Access Memory (“SRAM”) device, flash memory device, or other memory device. In at least one embodiment, memory 820 may store instruction(s) 819 and/or data 821 represented by data signals that may be executed by processor 802.

In at least one embodiment, system logic chip may be coupled to processor bus 810 and memory 820. In at least one embodiment, system logic chip may include, without limitation, a memory controller hub (“MCH”) 816, and processor 802 may communicate with MCH 816 via processor bus 810. In at least one embodiment, MCH 816 may provide a high bandwidth memory path 818 to memory 820 for instruction and data storage and for storage of graphics commands, data and textures. In at least one embodiment, MCH 816 may direct data signals between processor 802, memory 820, and other components in computer system 800 and to bridge data signals between processor bus 810, memory 820, and a system I/O 822. In at least one embodiment, system logic chip may provide a graphics port for coupling to a graphics controller. In at least one embodiment, MCH 816 may be coupled to memory 820 through a high bandwidth memory path 818 and graphics/video card 812 may be coupled to MCH 816 through an Accelerated Graphics Port (“AGP”) interconnect 814.

In at least one embodiment, computer system 800 may use system I/O 822 that is a proprietary hub interface bus to couple MCH 816 to I/O controller hub (“ICH”) 830. In at least one embodiment, ICH 830 may provide direct connections to some I/O devices via a local I/O bus. In at least one embodiment, local I/O bus may include, without limitation, a high-speed I/O bus for connecting peripherals to memory 820, chipset, and processor 802. Examples may include, without limitation, an audio controller 829, a firmware hub (“flash BIOS”) 828, a wireless transceiver 826, a data storage 824, a legacy I/O controller 823 containing user input and keyboard interfaces 825, a serial expansion port 827, such as Universal Serial Bus (“USB”), and a network controller 834, which may include in some embodiments, a data processing unit. Data storage 824 may comprise a hard disk drive, a floppy disk drive, a CD-ROM device, a flash memory device, or other mass storage device.

In at least one embodiment, FIG. 8 illustrates a system, which includes interconnected hardware devices or “chips,” whereas in other embodiments, FIG. 8 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 800 are interconnected using compute express link (CXL) interconnects. In at least one embodiment, system 800 can correspond to systems 100A-D or components thereof, such as devices 120A-N, 130A-N, 140A-N, 200, and connecting links 122A-N, 124A-N, 132A-N, 142A-N, and 210A-N.

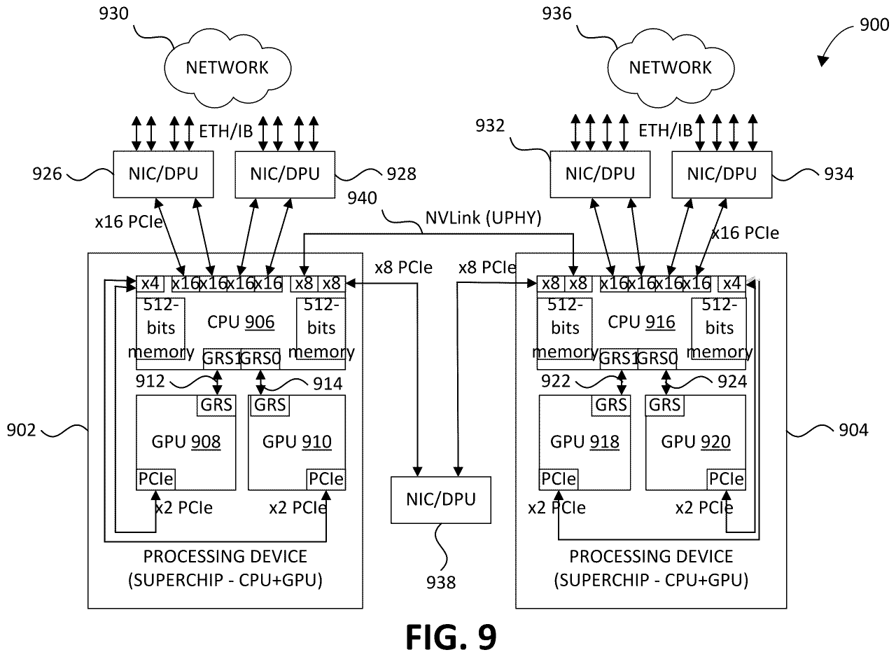

FIG. 9 is a block diagram of a computing system 900 having two processing devices coupled to each other and multiple networks according to at least one embodiment. The computing system 900 is designed with multiple integrated circuits (referred to as processing devices), where each integrated circuit includes a CPU and two GPUs, forming a powerful and flexible architecture. These processing devices are interconnected via an NVLink (or other high-speed interconnect), enabling high-speed communication between the processing devices, and are also connected through a Network Interface Card (NIC) or Data Processing Unit (DPU) to ensure efficient data transfer across the computing system 900. The coupling of processing devices through NVLink allows for seamless data exchange and parallel processing, enhancing overall computational performance. Additionally, these processing devices are connected to multiple networks through one or more network interface cards (NICs) or DPUs, enabling the system to handle complex, multi-network tasks with high bandwidth and low latency. This configuration makes the computing system 900 highly suitable for demanding applications that require significant processing power, such as artificial intelligence (AI), machine learning (ML), and data-intensive computing, while ensuring robust connectivity and scalability across various networked environments. The integrated circuits of the computing system 900 can include one or more CPUs and one or more GPUs. An example architecture of a multi-GPU architecture is illustrated in FIG. 9.

As illustrated in FIG. 9, the computing system 900 includes a processing device 902 with a multi-GPU architecture. In particular, the processing device 902 includes a CPU 906, a GPU 908, and a GPU 910. The CPU 906 can be coupled to the GPU 908 via an die-to-die (D2D) or chip-to-chip (C2C) interconnect 912, such as a Ground-Referenced Signaling interconnect (GRS interconnect). The CPU 906 can be coupled to the GPU 910 via a D2D or C2C interconnect 914. The CPU 906 can also couple to the GPU 908 and GPU 910 via PCIe interconnects. The CPU 906 can be coupled to one or more network interface cards (NICs) or data processing units (DPUs), which are coupled to one or more networks. For example, as illustrated in FIG. 9, the CPU 906 is coupled to a first NIC/DPU 926, which is coupled to a network 930. The CPU 906 is also coupled to a second NIC/DPU 928, which is coupled to the network 930. The NIC/DPU 926 and NIC/DPU 928 can be coupled to the network 930 over Ethernet (ETH) or InfiniBand (IB) connections.

The computing system 900 also includes a processing device 904 with a multi-GPU architecture. In particular, the processing device 904 includes a CPU 916, a GPU 918, and a GPU 920. The CPU 916 can be coupled to the GPU 918 via an D2D or C2C interconnect 922. The CPU 916 can be coupled to the GPU 920 via a D2D or C2C interconnect 924. The CPU 916 can also couple to the GPU 918 and GPU 920 via PCIe interconnects. The CPU 916 can be coupled to one or more NICs or DPUs, which are coupled to one or more networks. For example, as illustrated in FIG. 9, the CPU 916 is coupled to a first NIC/DPU 932, which is coupled to a network 936. The CPU 916 is also coupled to a second NIC/DPU 934, which is coupled to the network 936. The NIC/DPU 932 and NIC/DPU 934 can be coupled to the network 936 over Ethernet (ETH) or InfiniBand (IB) connections.

In at least one embodiment, the processing device 902 and the processing device 904 can communication with each other via a NIC/DPU 938, such as over PCIe interconnects. The processing device 902 and processing device 904 can also communicate with each other over a high-bandwidth communication interconnects 940, such as an NVLink interconnect or other high-speed interconnects.

In at least one embodiment, the computing system 900 is used for high-speed network communication and includes a processing unit (e.g., CPU 906, GPU 908, GPU 910, CPU 916, GPU 918, GPU 920, NIC/DPU 926, NIC/DPU 928, NIC/DPU 932, NIC/DPU 934, or NIC/DPU 938), a memory coupled to the processing unit(s), and a network interface coupled to the processing unit(s) and memory via a link of a communication interface. In various embodiments, one or more of the linked devices can include components described with reference to FIG. 2 for changing states in communication interface links using switch policies and APIs.

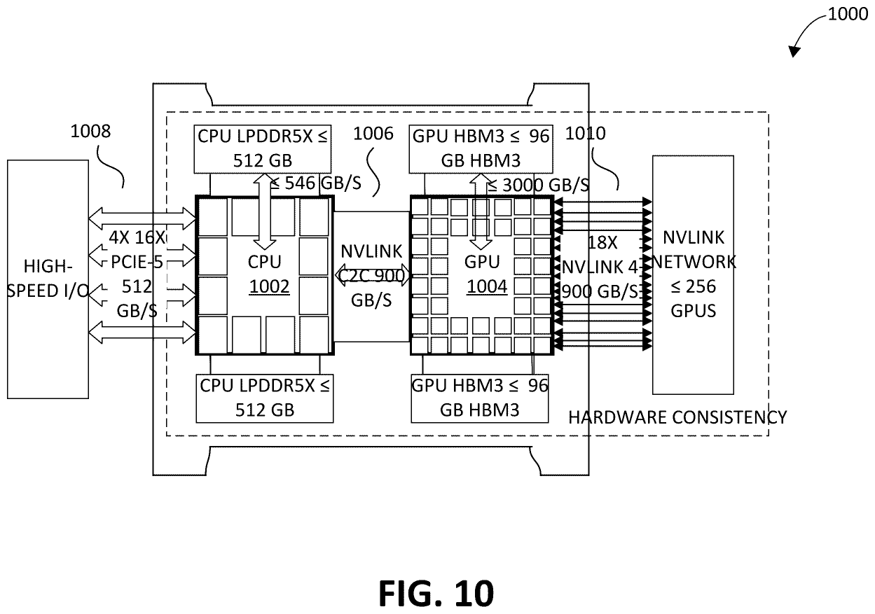

FIG. 10 is a block diagram of a computing system 1000 having a CPU 1002 and a GPU 1004 in a single integrated circuit according to at least one embodiment. The computing system 1000 can be a highly integrated design where a CPU 1002 and GPU 1004 are connected on a single integrated circuit, utilizing an NVLink C2C (Chip-to-Chip) interconnect 1006 to enable fast, low-latency communication between the two processing units. This close integration allows for efficient data transfer and parallel processing between the CPU 1002 and GPU 1004, optimizing performance for complex computational tasks. The GPU elements within the computing system 1000 can be interconnected using an NVLink network, allowing for scalability up to 256 GPU elements, creating a powerful, unified processing environment ideal for large-scale AI, ML, and high-performance computing applications. The NVLink network can be a GPU fabric of high-bandwidth communication interconnects 1010. Additionally, the computing system 1000 can be designed to interface with a high-speed I/O through PCIe interconnects 1008, ensuring rapid data transfer to and from external devices, further enhancing the system's capabilities in handling data-intensive tasks and providing robust connectivity to peripheral components. It should be noted that the C2C interconnects 1006 can be considered D2D interconnects since the CPU 1002 and the GPU 1004 are located on the same integrated circuit. The integrated circuit can include CPU memory (also referred to as main memory) and GPU memory, which are accessible by the CPU 1002 and the GPU 1004, respectively, over high-speed interconnects. The computing system 1000 can bring together performance of the GPU 1004 with the versatility of the CPU 1002. The CPU 1002 can be connected with a high-bandwidth and memory coherent C2C interconnects 1006 in a single integrated circuit. The computing system 1000 can support a link switch system.

In at least one embodiment, the computing system 1000 is used for high-speed network communication and includes a processing unit (e.g., CPU 1002, GPU 1004, NVLink network), a memory coupled to the processing unit(s), and a network interface coupled to the processing unit(s) and memory via a link of a communication interface. In various embodiments, one or more of the linked devices can include components described with reference to FIG. 2 for changing states in communication interface links using switch policies and APIs.

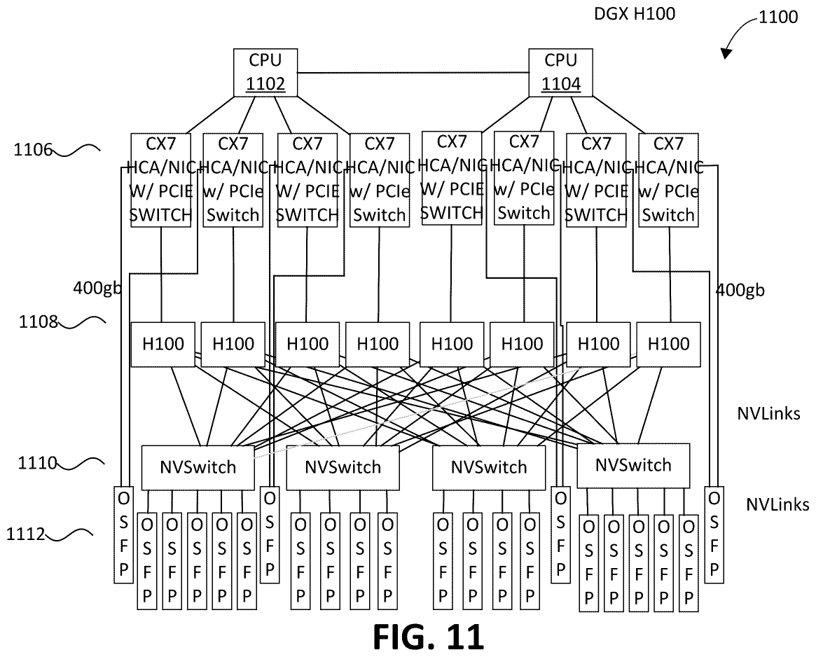

FIG. 11 is a block diagram of a computing system 1100 having tensor core GPUs 1108 according to at least one embodiment. The computing system 1100 can be a DGX H100 system, which is a high-performance computing platform designed to meet the demands of AI, ML, and deep learning (DL) workloads. The computing system 1100 can include multiple tensor core GPUs 1108 (e.g., NVIDIA H100 Tensor Core GPUs). The tensor core GPUs 1108 can each be one of the integrated circuits described above with respect to FIG. 10. The tensor core GPUs 1108 can be optimized for AI/ML/DL applications, offering exceptional performance for deep learning training, inference, and high-performance computing tasks. The tensor core GPUs 1108 within the computing system 1100 are interconnected using high-speed communication interfaces like NVLinks, enabling rapid data transfer between them, which is crucial for handling large-scale AI models and datasets with low latency. This computing system 1100 is designed for scalability, allowing for the integration of additional GPUs as required, making it versatile enough for research, development, and deployment in data centers for production AI workloads. Each GPU is equipped with Tensor Cores, specialized processing units that accelerate matrix operations, a fundamental component of AI and deep learning algorithms. These Tensor Cores enable the system to perform mixed-precision calculations efficiently, balancing speed and accuracy. Given the power consumption and heat generation of multiple tensor core GPUs 1108, the computing system 1100 can include advanced cooling solutions and power management features to ensure safe operation while maintaining peak performance. It is supported by a comprehensive software ecosystem, including NVIDIA's CUDA programming model, AI frameworks like TensorFlow and PyTorch, and other HPC and AI software tools, which enable developers and researchers to harness the full power of the tensor core GPUs 1108 for their specific applications. The computing system 1100 is ideally suited for large-scale AI model training, real-time inference, scientific simulations, data analytics, and other compute-intensive tasks that require massive parallel processing power.

The tensor core GPUs 1108 can be coupled to multiple CPUs, such as CPU 1102 and CPU 1104, using switches 1106 (e.g., CX7 HCA/NIC with PCIe switch). The tensor core GPUs 1108 can be coupled to each other via switches 1110 (e.g., NVSwitches). The switches 1106 and switches 1110 can be coupled to high-speed transceiver modules 1112. The high-speed transceiver modules 1112 can be Octal Small Form-factor Pluggable (OSFP) modules. OSFP modules refer to high-speed transceiver modules designed for rapid data communication, particularly in environments requiring significant bandwidth, such as data centers and high-performance computing systems. These modules support extremely high data rates, typically up to 400 Gbps per module, with future capabilities extending to 800 Gbps or more. OSFP modules interface with the system via the PCIe interface, enabling fast and efficient data transfer between the integrated CPU-GPU components and external networks or other connected systems. Their hot-pluggable nature allows for easy insertion or removal without the need to power down the system, offering flexibility and ease of maintenance, which is crucial in critical-uptime environments. Additionally, OSFP modules are designed for high density, maximizing the number of high-speed connections within limited space, such as in densely packed server racks. By adhering to the latest networking standards, OSFP modules ensure the computing system 1100 remains capable of meeting increasing data demands and can be upgraded to support future advancements in network speeds, thus contributing to the system's overall performance and scalability.

In at least one embodiment, the computing system 1100 can be considered a data-network configuration with full-bandwidth intra-server NVLinks. In this example, all eight tensor core GPUs 1108 can simultaneously saturate eighteen NVLinks to other GPUs within the server. The bandwidth is limited by over-subscription from multiple other GPUs. In another embodiments, data-network configuration can be a half-bandwidth intra-server NVLinks. In this example, all eight tensor core GPUs 1108 can half-subscribe eighteen NVLinks to GPUs in other servers. Four tensor core GPUs 1108 can saturate eighteen NVLinks to GPUs in other servers. This is equivalent of full-bandwidth on AllReduce with Scalable Hierarchical Aggregation and Reduction Protocol (SHARP). The reduction in all-2-all (All2All) bandwidth is a balance with server complexity and costs. In at least one embodiment, all eight tensor core GPUs 1108 can independently transfer data, using Remote Direct Memory Access (RDMA) protocol, over its own dedicated switch (e.g., 400 Gb/s HCA/NIC) in a multi-rail InfiniBand/Ethernet configuration. In this example, 800 GBps of aggregate full-duplex to non-NVLink network devices.

In at least one embodiment, the computing system 1100 is used for high-speed network communication and includes a processing unit (e.g., CPU 1102, CPU 1102, switches 1106, tensor core GPUs 1108, switches 1110, high-speed transceiver modules 1112), and a network interface coupled to the processing unit via a link of a communication interface. In various embodiments, one or more of the linked devices can include components described with reference to FIG. 2 for changing states in communication interface links using switch policies and APIs.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items but may be more when so indicated either explicitly or by context. Further, unless stated otherwise or otherwise clear from context, phrase “based on” means “based at least in part on” and not “based solely on.”

Operations of processes described herein may be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors-for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data may be accomplished in a variety of ways such as by receiving data as a parameter of a function call or a call to an application programming interface. In some implementations, process of obtaining, acquiring, receiving, or inputting analog or digital data may be accomplished by transferring data via a serial or parallel interface. In another implementation, process of obtaining, acquiring, receiving, or inputting analog or digital data may be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data may be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system comprising:
a switch connected to a plurality of devices via a plurality of respective links of a communication interface, wherein the switch is to perform operations comprising:
receiving, from a first device of the plurality of devices, a performance message conforming to a protocol of the communication interface; and
determining, based on the received performance message and a link bandwidth policy, that a first bandwidth of a first link between the switch and the first device of the plurality of devices is to be updated to a second bandwidth.

2. The system of claim 1, the operations further comprising:
causing the first bandwidth of the first link to be updated to the second bandwidth.

3. The system of claim 2, wherein the switch is associated with a multi-lane communication interface, and wherein causing the first bandwidth of the first link to be updated to the second bandwidth comprises:
causing a first link width associated with the first bandwidth to be resized to a second link width associated with the second bandwidth.

4. The system of claim 1, wherein the received performance message is to be forwarded to a second device of the plurality of devices.

5. The system of claim 1, wherein the link bandwidth policy is associated with an application, and wherein the application is one of: a high-performance computing (HPC) application, an artificial intelligence (AI) application, or a gaming application.

6. The system of claim 5, the operations further comprising:
receiving the link bandwidth policy from the application.

7. The system of claim 1, wherein the performance message is associated with the first bandwidth of the first link or a latency of the first link.

8. A system comprising:
a switch connected to a plurality of devices via a plurality of respective links of a communication interface, wherein the switch is to perform operations comprising:
receiving, from a first device of the plurality of devices, a performance message conforming to an application programming interface (API) of the switch; and
determining, based on the received performance message and a link bandwidth policy, that a first bandwidth of a first link between the switch and the first device of the plurality of devices is to be updated to a second bandwidth.

9. The system of claim 8, the operations further comprising:
causing the first bandwidth of the first link to be updated to the second bandwidth.

10. The system of claim 9, wherein the switch is associated with a multi-lane communication interface, and wherein causing the first bandwidth of the first link to be updated to the second bandwidth comprises:
causing a first link width associated with the first bandwidth to be resized to a second link width associated with the second bandwidth.

11. The system of claim 8, wherein the received performance message is a request to update the first bandwidth of the first link.

12. The system of claim 8, wherein the link bandwidth policy is associated with an application, and wherein the application is one of: a high-performance computing (HPC) application, an artificial intelligence (AI) application, or a gaming application.

13. The system of claim 12, the operations further comprising:
receiving the link bandwidth policy from the application.

14. The system of claim 8, wherein the performance message is associated with the first bandwidth of the first link or a latency of the first link.

15. A system comprising:
a switch connected to a plurality of devices via a plurality of respective links of a communication interface, wherein the switch is to perform operations comprising:
receiving, from a software endpoint, a performance message conforming to an application programming interface (API) of the switch; and
determining, based on the received performance message and a link bandwidth policy, that a first bandwidth of a first link between the switch and a first device of the plurality of devices is to be updated to a second bandwidth.

16. The system of claim 15, the operations further comprising:
causing the first bandwidth of the first link to be updated to the second bandwidth.

17. The system of claim 16, wherein the switch is associated with a multi-lane communication interface, and wherein causing the first bandwidth of the first link to be updated to the second bandwidth comprises:
causing a first link width associated with the first bandwidth to be resized to a second link width associated with the second bandwidth.

18. The system of claim 15, wherein the link bandwidth policy is associated with an application, and wherein the application is one of: a high-performance computing (HPC) application, an artificial intelligence (AI) application, or a gaming application.

19. The system of claim 18, the operations further comprising:
receiving the link bandwidth policy from the application.

20. The system of claim 15, wherein the performance message is associated with the first bandwidth of the first link or a latency of the first link.

21. A system for high-speed network communication in a data center, the system comprising:
one or more processing units;
a memory coupled to the one or more processing units;
a switch coupled to the one or more processing units and the memory via a plurality of respective links; and
a network interface coupled to the switch via the plurality of respective links, wherein the switch is to perform operations comprising:
receiving, from the network interface, a performance message conforming to a protocol of the communication interface; and
determining, based on the received performance message and a link bandwidth policy, that a first bandwidth of a first link between the switch and the network interface is to be updated to a second bandwidth.

22. The system of claim 21, the operations further comprising:
causing the first bandwidth of the first link to be updated to the second bandwidth.

23. The system of claim 22, wherein the switch is associated with a multi-lane communication interface, and wherein causing the first bandwidth of the first link to be updated to the second bandwidth comprises:
causing a first link width associated with the first bandwidth to be resized to a second link width associated with the second bandwidth.

24. The system of claim 21, wherein the received performance message is to be forwarded to a second device.

25. The system of claim 21, wherein the link bandwidth policy is associated with an application, and wherein the application is one of: a high-performance computing (HPC) application, an artificial intelligence (AI) application, or a gaming application.

26. The system of claim 25, the operations further comprising:
receiving the link bandwidth policy from the application.

27. The system of claim 21, wherein the performance message is associated with the first bandwidth of the first link or a latency of the first link.
